(19) United States
(12) Patent Application Publication
(10) Pub. No.: US 2019/0061780 A1
(43) Pub. Date: Feb. 28, 2019

(54) DRIVING ASSIST SYSTEM USING NAVIGATION INFORMATION AND OPERATING METHOD THEREOF

(71) Applicants: Hyundai Motor Company, Seoul (KR); Kia Motors Corporation, Seoul (KR)

(72) Inventors: Young Min Han, Gunpo (KR); Beom Jun Kim, Seoul (KR); Kyoung Jun Lee, Seoul (KR); Doo Jin Um, Seoul (KR); Dong Gu Lee, Seoul (KR); Dong Eon Oh, Seoul (KR); Hyun Jae Yoo, Seoul (KR); Min Chul Kang, Uiwang (KR); Dae Young Kim, Gwangmyeong (KR); Seung Geon Moon, Hwaseong, Gyeonggi-do (KR); Sung Woo Choi, Gwangmyeong, Gyeonggi-do (KR); Chan Il Park, Chungcheongbuk-do (KR); Sung Yoon Yeo, Seoul (KR); Jee Young Kim, Yongin (KR); Hoi Won Kim, Gwacheon (KR)

(21) Appl. No.: 15/816,624

(22) Filed: Nov. 17, 2017

(30) Foreign Application Priority Data
Aug. 29, 2017 (KR) 10-2017-0109471

(51) Int. Cl. B60W 50/08; B60W 30/14; B60W 30/18; B60W 50/14; G05D 1/00

(52) U.S. Cl. CPC B60W 50/087; B60W 30/143; B60W 30/18163; B60W 2550/14; G05D 1/0061; B60W 2050/146; B60W 2550/402; B60W 50/14

(57) ABSTRACT

A driving assist system for a vehicle using navigation information includes: a navigation device providing navigation information; a controller determining whether the vehicle deviates from a navigation route based on a driving lane of the vehicle at or near a junction of a highway, and when the controller determines that the vehicle deviates from the navigation route, performing at least one driving assist operation based on information of a road on which the vehicle is currently driving; and a display device displaying the information of the road on which the vehicle is currently driving.

### CROSS-REFERENCE TO RELATED APPLICATION

This application claims the benefit of priority to Korean Patent Application No. 10-2017-0109471, filed on Aug. 29, 2017 in the Korean Intellectual Property Office, the disclosure of which is incorporated herein in its entirety by reference as if fully set forth herein.

### TECHNICAL FIELD

The present disclosure relates generally to a driving assist system using navigation information and an operating method thereof and, more particularly, to a driving assist system that assists the driving of a vehicle based on navigation information corresponding to a navigation route.

### BACKGROUND

Recently, in order to increase the safety of drivers, vehicles have been provided with various safety-enhancing systems including a highway driving assist (HDA) system, a lane departure warning system (LDWS), a lane keeping assist system (LKAS), a blind spot detection (BSD) system, an advanced smart cruise control (ASCC) system, an autonomous emergency braking (AEB) system, a traffic jam assist (TJA) system, and many others. In particular, the HDA system is capable of performing a partially automated driving function, and allows a subject vehicle to track the trajectory of a preceding vehicle while keeping the vehicle in a given lane. In the HDA system, the driver should manually operate the vehicle when changing lanes or entering a divided road such as an interchange (IC) or a junction (JC).

An upgraded HDA2 system, however, may allow the vehicle to change lanes or enter a divided road automatically if the driver only turns on a turn signal. The conventional HDA2 system may perform a partially automated driving function based on navigation information corresponding to a navigation route acquired from a navigation device. When the vehicle deviates from the navigation route due to the driver's operation, the HDA2 system may perform the partially automated driving function based on erroneous navigation information until the navigation device recognizes the deviation of the vehicle from the route and creates a new route. Thus, the reliability of system performance may be degraded.

In other words, when the vehicle deviates from the navigation route, the conventional HDA2 system may fail to acquire the navigation information necessary for the navigation device to recognize the deviation and create a new route. As a result, the conventional HDA2 system may be unable to perform the partially automated driving function based on erroneous navigation information or may fail to provide the partially automated driving function.

### SUMMARY

The present disclosure has been made to solve the above-mentioned problems occurring in the related art while advantages achieved by related prior art are maintained intact.

An aspect of the present disclosure provides a driving assist system using navigation information capable of determining whether or not the vehicle deviates from a navigation route on the basis of a driving lane of the vehicle at a highway junction, and an operating method thereof, in order to assist the driving of a vehicle without errors even when the vehicle deviates from the navigation route.

The objects of the present disclosure are not limited to the foregoing, and any other objects and advantages not mentioned herein will be clearly understood from the following description. The present inventive concept will be more clearly understood from disclosed embodiments of the present disclosure. In addition, it will be apparent that the objects and advantages of the present disclosure can be achieved by elements and features claimed in the claims and a combination thereof.

According to embodiments of the present disclosure, a driving assist system for a vehicle using navigation information includes: a navigation device providing navigation information; a controller determining whether the vehicle deviates from a navigation route based on a driving lane of the vehicle at or near a junction of a highway, and when the controller determines that the vehicle deviates from the navigation route, performing at least one driving assist operation based on information of a road on which the vehicle is currently driving; and a display device displaying the information of the road on which the vehicle is currently driving.

The at least one driving assist operation performed by the controller may include at least one of: an auto-setting function for setting a longitudinal control speed of the vehicle to a speed limit of the driving road, a lane change assist function for assisting a lane change when a driver operates a turn signal, and a speed control function for reducing a speed of the vehicle at an exit ramp of the highway.

The controller may determine that the vehicle deviates from the navigation route when: (a) the navigation route includes a path allowing the vehicle to pass through an exit ramp at the junction and (b) the vehicle does not keep travelling on a lane of the highway connected to the exit ramp until reaching the junction. In addition, the controller may activate the auto-setting function and the lane change assist function, and deactivates the speed control function. In addition, the controller may control the display device to display the information of the road on which the vehicle is currently driving while the vehicle drives on the highway.

The controller may determine that the vehicle deviates from the navigation route when: (a) the navigation route includes a path allowing the vehicle to keep travelling on the highway without travelling onto an exit ramp at the junction and (b) the vehicle keeps travelling on a lane of the highway connected to the exit ramp until reaching the junction. In addition, the controller may perform the at least one driving assist operation based on information of the exit ramp on which the vehicle is currently driving when the controller determines that the vehicle deviates from the navigation route. In addition, the controller may deactivate the auto-setting function and the lane change assist function, and activates the speed control function. In addition, the controller may control the display device to display the information of the road on which the vehicle is currently driving while the vehicle drives on the exit ramp.

Furthermore, according to embodiments of the present disclosure, an operating method of a driving assist system for a vehicle using navigation information includes: providing, by a navigation device, navigation information; determining, by a controller, whether the vehicle deviates from a navigation route based on a driving lane of the vehicle at or near a junction of a highway; performing, by the controller, at least one driving assist operation based on information of a road on which the vehicle is currently driving when the vehicle deviates from the navigation route; and displaying, by a display device, the information of the road on which the vehicle is currently driving.

The at least one driving assist operation may include at least one of: an auto-setting function for setting a longitudinal control speed of the vehicle to a speed limit of the driving road, a lane change assist function for assisting a lane change when a driver operates a turn signal, and a speed control function for reducing a speed of the vehicle at an exit ramp of the highway.

The determining of whether the vehicle deviates from a navigation route may include determining that the vehicle deviates from the navigation route when: (a) the navigation route includes a path allowing the vehicle to pass through an exit ramp at the junction and (b) the vehicle does not keep travelling on a lane of the highway connected to the exit ramp until reaching the junction. The performing of the at least one driving assist operation may include performing the at least one driving assist operation based on information of the highway on which the vehicle is currently driving when it is determined that the vehicle deviates from the navigation route. In addition, the performing of the at least one driving assist operation may include activating the auto-setting function and the lane change assist function, and deactivating the speed control function. In addition, the method may further include controlling the display device to display the information of the road on which the vehicle is currently driving while the vehicle drives on the highway.

The determining of whether the vehicle deviates from a navigation route may include determining that the vehicle deviates from the navigation route when: (a) the navigation route includes a path allowing the vehicle to keep travelling on the highway without travelling onto an exit ramp at the junction and (b) the vehicle keeps travelling on a lane of the highway connected to the exit ramp until reaching the junction. The performing of the at least one driving assist operation may include performing the at least one driving assist operation based on information of the exit ramp on which the vehicle is currently driving when it is determined that the vehicle deviates from the navigation route. In addition, the performing of the at least one driving assist operation may include deactivating the auto-setting function and the lane change assist function, and activating the speed control function. In addition, the method may further include controlling the display device to display the information of the road on which the vehicle is currently driving while the vehicle drives on the exit ramp.

### BRIEF DESCRIPTION OF THE DRAWINGS

The above and other objects, features and advantages of the present disclosure will be more apparent from the following detailed description taken in conjunction with the accompanying drawings:

FIG. 1 illustrates the configuration of a driving assist system using navigation information, according to embodiments of the present disclosure;

FIG. 2 illustrates the configuration of a navigation device in a driving assist system using navigation information, according to embodiments of the present disclosure;

FIGS. 3 and 4 illustrate a process of assisting partially automated driving of a vehicle in a driving assist system using navigation information, according to embodiments of the present disclosure;

FIGS. 5 and 6 illustrate an additional process of assisting partially automated driving of a vehicle in a driving assist system using navigation information, according to embodiments of the present disclosure;

FIG. 7 illustrates the configuration of a controller in a driving assist system using navigation information, according to embodiments of the present disclosure; and

FIG. 8 illustrates a flowchart of an operating method of a driving assist system using navigation information, according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. In the drawings, the same reference numerals will be used throughout to designate the same or equivalent elements. In addition, a detailed description of well-known techniques associated with the present disclosure will be ruled out in order not to unnecessarily obscure the gist of the present disclosure.

Terms such as first, second, A, B, (a), and (b) may be used to describe the elements in embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Furthermore, the controller of the present disclosure may be embodied as non-transitory computer readable media containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

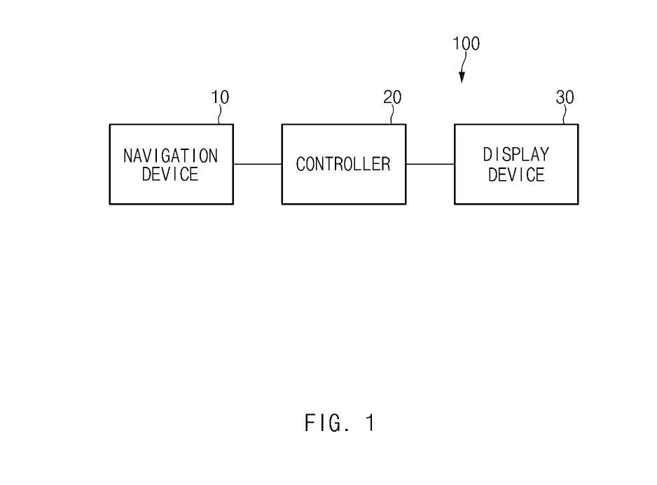

Referring now to embodiments of the present disclosure, FIG. 1 illustrates the configuration of a driving assist system using navigation information, according to embodiments of the present disclosure.

As illustrated in FIG. 1, a driving assist system 100 using navigation information, according to embodiments of the present disclosure, may include a navigation device 10, a controller 20, and a display device 30.

With regard to each of the aforementioned elements, the navigation device 10 may be mounted in a vehicle, and generate and guide a route to a destination that is input by a driver.

In addition, the navigation device 10 may provide navigation information to the controller 20. The navigation information may include navigation information corresponding to a navigation route (e.g., a main route), and navigation information corresponding to a bypass route at a junction. Here, when the navigation route does not include a path that is divided at a junction, a bypass route at the junction refers to an exit ramp, and when the navigation route includes a path that is divided at the junction, a bypass route at the junction refers to a highway.

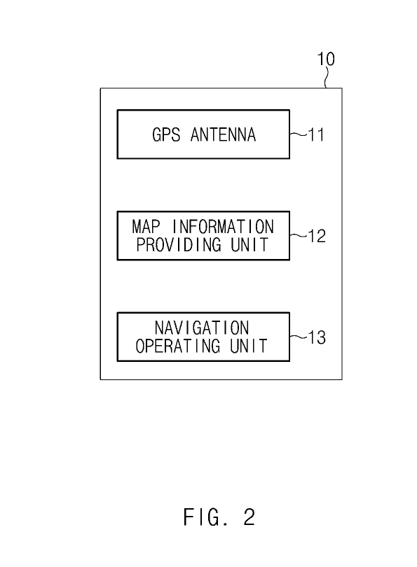

The navigation device 10 may identify location information and driving environment information of the vehicle by matching location coordinates of the vehicle identified through a satellite signal on a previously stored map, and provide the identified information to the controller 20. To this end, the navigation device 10, according to an exemplary embodiment, may include, as illustrated in FIG. 2, a global positioning system (GPS) antenna 11 receiving satellite signals, a map information providing unit 12 providing a map including geographical information, and a navigation operating unit 13 receiving external control commands.

The navigation device 10 may receive control commands from the outside through the navigation operating unit 13, and operate according to the control command. For example, the navigation operating unit 13 may receive a power on/off command, a volume control command, a destination selection command, and the like. In addition, the navigation operating unit 13 may receive a route search command and a re-routing command.

To this end, the navigation operating unit 13 may be provided as a display unit including an operating section provided on a spoke of the vehicle, a dial operating section provided on a gear box, and a touch panel. Here, the spoke is a portion connecting a rim of a steering wheel to a hub of a rotary shaft for steering.

The navigation device 10 may receive a satellite signal from a GPS satellite via the GPS antenna 11. Here, the satellite signal may include the location coordinates of the vehicle.

After acquiring the location coordinates, the navigation device 10 may match the location coordinates acquired through the GPS antenna 11 on the map provided by the map information providing unit 12. To this end, the map information providing unit 12 may store the map in advance.

Specifically, the map information providing unit 12 may store precise map information in advance. Here, the precise map information may have high accuracy for safe and precise vehicle control, and may contain map information including information related to road plane position, elevation, slope, curvature, number of lanes, and the like, and further including information related to road facilities such as traffic regulatory signs, traffic lights, speed cameras. In addition, the precise map may include road attribute information. Here, the road attribute information refers to road link information, and examples of the link information include general roads, highways, exit ramps, overpasses, bridges, tunnels, underpasses, junctions, and the like.

To this end, the map information providing unit 12 may be provided as at least one storage medium selected from among a flash memory, a hard disk, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk, and the like.

After matching the location coordinates of the vehicle on the map, the navigation device 10 may transmit the location information of the vehicle matched on the map to the controller at predetermined intervals. For example, the navigation device 10 may transmit the location information of the vehicle as an electrical signal to the controller 20 every second.

In addition, the navigation device 10 may identify the attribute information of a driving road. As described above, since the map provided by the map information providing unit 12 includes the attribute information for each road, the navigation device 10 may identify the attribute information of the driving road on which the vehicle is located.

In addition, the navigation device 10 may identify driving environment information on a predetermined driving path. Here, the driving path may include a driving path predetermined according to a destination input from the outside through the navigation operating unit 13, and a most probable path (MPP) determined according to a probability without inputting a destination.

Here, the identified driving environment information refers to environmental conditions for automated driving, and may include, for example, information on speed cameras, speed bumps, road gradient, road curvature, and the like, in front of the vehicle, but is not limited thereto.

The navigation device 10 may check the driving environment information once at the time of entry into a predetermined distance or area from the environmental conditions. For example, when the vehicle enters an area at a distance of 2 km from a speed camera on a driving path, the navigation device 10 may identify the driving environment information that the speed camera exists 2 km ahead.

The navigation device 10 may generate a message including the driving environment information and the driving road attribute information, independently of the location information transmitted at predetermined intervals, and transmit the generated message to the controller 20 once. Here, the message may be generated by grouping a series of electrical signals for a predetermined time. The message, according to embodiments of the present disclosure, may be provided in the order of driving road attribute information and driving environment information.

The controller 20 may perform overall control to assist the driving of the vehicle. The controller 20 may be a microprocessor, as expressed hereinabove.

The controller 20 may perform at least one driving assist operation to assist the driving of the vehicle based on the navigation information corresponding to the navigation route acquired from the navigation device 10. Here, the driving assist operations performed by the controller 20 may include, for example, an auto-setting function (hereinafter also referred to as “function A”) for automatically setting a longitudinal control speed to a speed limit of a road on which the vehicle is currently located, a lane change assist function (hereinafter also referred to as “function B”) for assisting a lane change when the driver operates a turn signal, and a speed control function (hereinafter also referred to as “function C”) for controlling (reducing) the speed of the vehicle at the exit ramp of the highway.

In other words, when the vehicle is driving on the highway, the controller 20 may activate the auto-setting function and the lane change assist function and deactivate the speed control function for the exit ramp, and when the vehicle is driving on the exit ramp, the controller 20 may deactivate the auto-setting function and the lane change assist function and activate the speed control function for the exit ramp.

In addition, when the junction (i.e., a point at which the exit ramp starts) is located on the navigation route, the controller 20 may determine whether or not the vehicle travels onto the exit ramp at the junction. In other words, when the vehicle travels on a lane of the highway connected to the exit ramp until reaching the junction, the controller 20 may determine that the vehicle is travelling onto the exit ramp. When the vehicle changes a lane before the junction while traveling on the lane of the highway connected to the exit ramp, the controller 20 may determine that the vehicle keeps travelling on the highway without travelling onto the exit ramp.

Here, in a case in which the navigation route includes a path allowing the vehicle to pass through the exit ramp at the junction, when the vehicle keeps travelling on the lane of the highway connected to the exit ramp until reaching the junction, the controller 20 may determine that the vehicle is travelling along the navigation route normally, and control the speed control function at the exit ramp on the basis of navigation information corresponding to the navigation route. On the other hand, when the vehicle does not keep travelling on the lane of the highway connected to the exit ramp until reaching the junction, the controller 20 may determine that the vehicle deviates from the navigation route, and control the auto-setting function and the lane change assist function on the basis of navigation information corresponding to a bypass route (highway) at the junction.

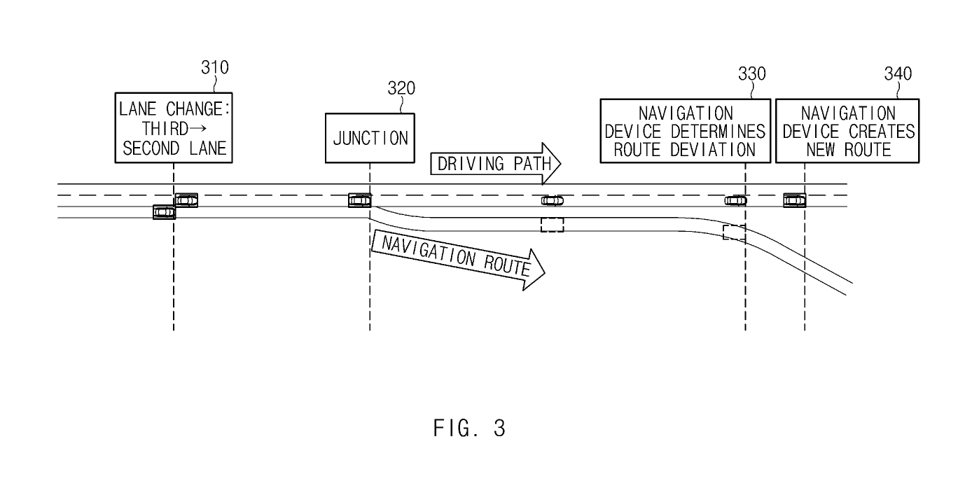

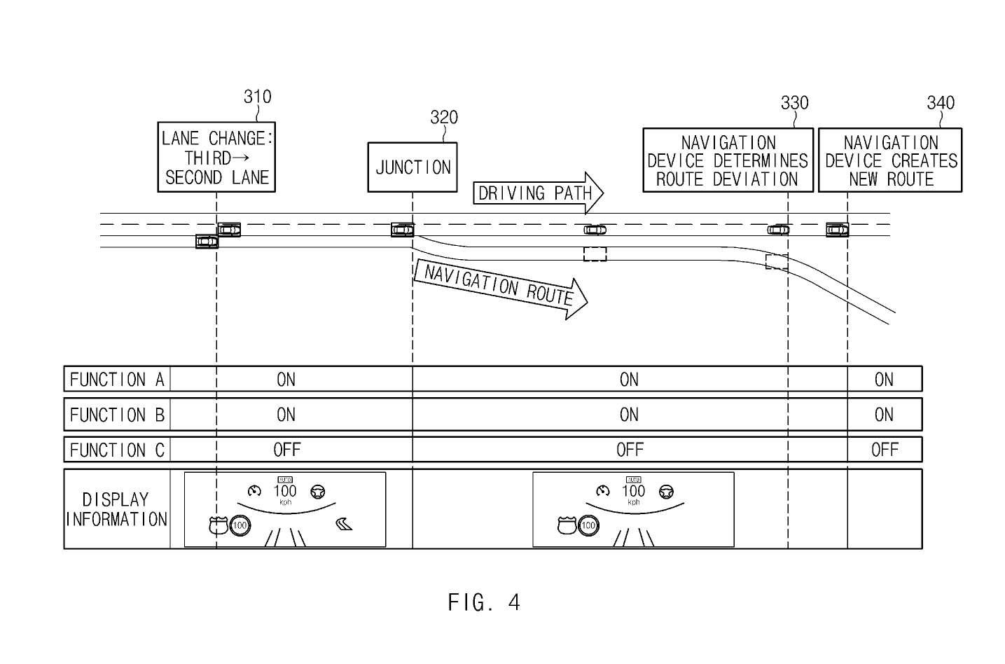

Hereinafter, referring to FIGS. 3 and 4, when a navigation route includes a path allowing a vehicle to pass through an exit ramp at a junction, and the vehicle deviates from the navigation route, a process of activating function A, function B, and function C will be described below.

In FIG. 3, “310” denotes a point in time at which the vehicle changes from a third lane to a second lane on the highway, “320” denotes a point at which the exit ramp of the highway starts, “330” denotes a point in time at which the navigation device 10 recognizes the deviation of the vehicle from the route, and “340” denotes a point in time at which the navigation device 10 creates a new route.

First of all, the controller 20 may acquire navigation information from the navigation device 10. Here, the navigation information may include navigation information (e.g., elevation, slope, curvature, number of lanes, traffic regulatory signs, traffic lights, speed cameras, link information, and the like) corresponding to a navigation route (e.g., main route), and navigation information (e.g., elevation, slope, curvature, number of lanes, traffic regulatory signs, traffic lights, speed cameras, link information, and the like) corresponding to a bypass route at a junction.

The controller 20 may detect whether or not the vehicle is travelling on a lane connected to the exit ramp when passing through the junction 320, to determine whether or not the vehicle deviates from the navigation route. Here, the controller 20 may activate logic for determining the deviation of the vehicle at a point in time at which the vehicle enters an area within a reference distance from the junction, and deactivate the logic when the determination has been completed.

Since the vehicle is traveling to a lane other than the lane of the highway connected to the exit ramp when passing through the junction in FIG. 3, it may be determined that the vehicle deviates from the navigation route. In other words, since the vehicle deviates from the navigation route and is travelling on the highway, the controller 20 may activate function A and function B and deactivate function C, on the basis of navigation information (e.g., highway information) corresponding to a bypass route at the junction.

The controller 20 may maintain such a control process until the navigation device 10 creates a new route (in other words, the controller 20 may check whether the navigation device 10 creates a new navigation route), and determine whether to activate function A, function B, and function C on the basis of navigation information corresponding to the new navigation route created by the navigation device 10 after the navigation device 10 creates the new navigation route.

In addition, since the vehicle deviates from the navigation route at the junction 320 and is travelling on the highway, the controller 20 may control the display device 30 to display information such as speed limit of the highway as illustrated in FIG. 4.

Meanwhile, in a case in which a navigation route includes a path allowing the vehicle to keep travelling on the highway without travelling onto the exit ramp at the junction, when the vehicle does not keep travelling on the lane of the highway connected to the exit ramp until reaching the junction, the controller 20 may determine that the vehicle is travelling along the navigation route normally, and control the auto-setting function and the lane change assist function on the basis of navigation information corresponding to the navigation route. On the other hand, when the vehicle keeps travelling on the lane of the highway connected to the exit ramp until reaching the junction, the controller 20 may determine that the vehicle deviates from the navigation route, and control the speed of the vehicle on the basis of navigation information (e.g., exit ramp information) corresponding to a bypass route at the junction.

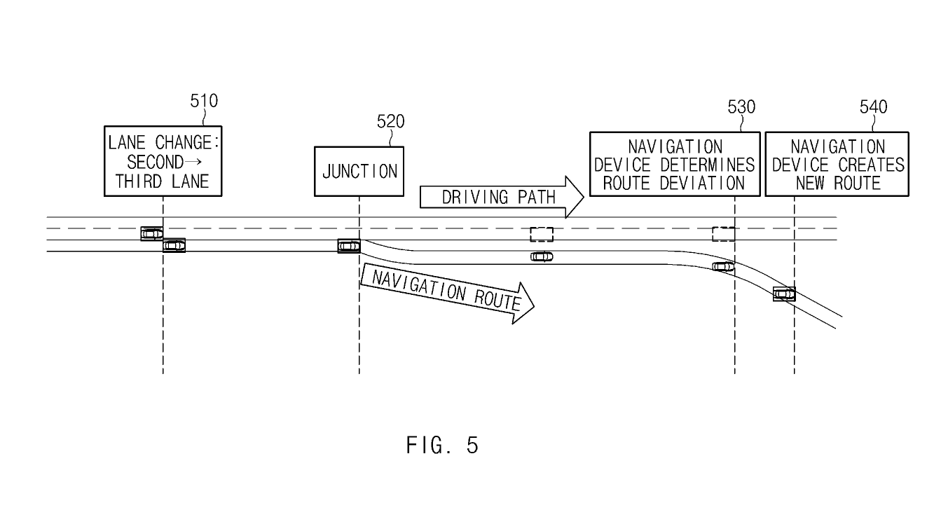

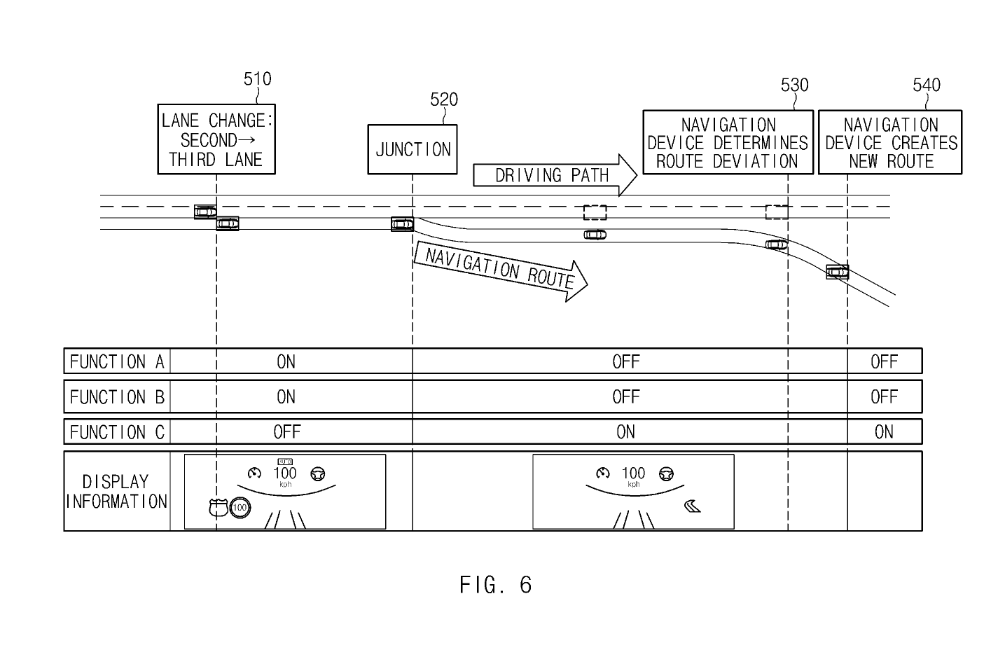

Hereinafter, referring to FIGS. 5 and 6, when a navigation route includes a path allowing a vehicle to keep travelling on a highway without travelling onto an exit ramp at a junction, and the vehicle deviates from the navigation route, a process of activating function A, function B, and function C will be described below.

In FIG. 5, “510” denotes a point in time at which the vehicle changes from a second lane to a third lane on the highway, “520” denotes a point at which the exit ramp of the highway starts, “530” denotes a point in time at which the navigation device 10 recognizes the deviation of the vehicle from the route, and “540” denotes a point in time at which the navigation device 10 creates a new route.

First of all, the controller 20 may acquire navigation information from the navigation device 10. Here, the navigation information may include navigation information (e.g., elevation, slope, curvature, number of lanes, traffic regulatory signs, traffic lights, speed cameras, link information, and the like) corresponding to a navigation route (e.g., main route), and navigation information (e.g., elevation, slope, curvature, number of lanes, traffic regulatory signs, traffic lights, speed cameras, link information, and the like) corresponding to a bypass route at a junction.

The controller 20 may detect whether or not the vehicle is travelling on a lane connected to the exit ramp when passing through the junction 520, to determine whether or not the vehicle deviates from the navigation route. Since the vehicle is traveling to the lane of the highway connected to the exit ramp when passing through the junction in FIG. 5, it may be determined that the vehicle deviates from the navigation route.

In other words, since the vehicle deviates from the navigation route and is travelling onto the exit ramp, the controller 20 may deactivate function A and function B and activate function C, on the basis of navigation information (e.g., exit ramp information) corresponding to a bypass route at the junction.

The controller 20 may maintain such a control process until the navigation device 10 creates a new navigation route, and determine whether to activate function A, function B, and function C on the basis of navigation information corresponding to the new navigation route created by the navigation device 10 after the navigation device 10 creates the new navigation route.

In addition, since the vehicle deviates from the navigation route at the junction 520 and is travelling on the exit ramp, the controller 20 may control the display device 30 to display the exit ramp information (e.g., an icon indicating deceleration) as illustrated in FIG. 6.

Next, the display device 30 may display various types of information under the control of the controller 20.

In particular, the display device 30 may provide a user interface (UI) that provides the driver with vehicle information in the form of images or texts. To this end, the display device 30 may be embedded in a center fascia (or console) of the vehicle. However, the installation of the display device is not limited thereto. Alternatively, the display device 30 may be provided to be separable from the center fascia of the vehicle.

Here, the display device 30 may be a liquid crystal display (LCD), a light emitting diode (LED), a plasma display panel (PDP), an organic light emitting diode (OLED), a cathode ray tube (CRT), or the like, but is not limited thereto.

In addition, the display device 30 may include a touch panel to detect a touch input. Accordingly, the display device 30 may receive a control command from the outside through the touch input, and operate according to the control command.

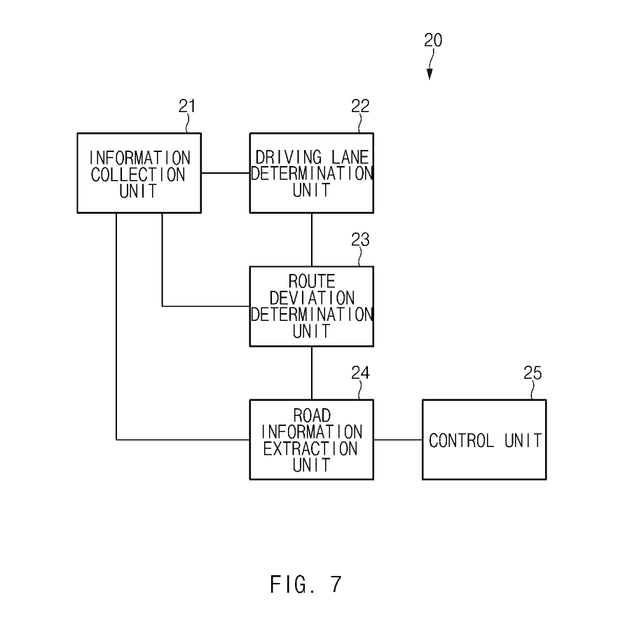

FIG. 7 illustrates the configuration of a controller in a driving assist system using navigation information, according to embodiments of the present disclosure.

As illustrated in FIG. 7, the controller 20 in the driving assist system 100 using navigation information, according to embodiments of the present disclosure, may include an information collection unit 21, a driving lane determination unit 22, a route deviation determination unit 23, a road information extraction unit 24, and a control unit 25.

The information collection unit 21 may collect navigation information from the navigation device 10. Here, the navigation information may include navigation information (e.g., elevation, slope, curvature, number of lanes, traffic regulatory signs, traffic lights, speed cameras, link information, and the like) corresponding to a navigation route (e.g., main route), and navigation information (e.g., elevation, slope, curvature, number of lanes, traffic regulatory signs, traffic lights, speed cameras, link information, and the like) corresponding to a bypass route at a junction.

In addition, when it is determined by the route deviation determination unit 23 that the vehicle deviates from the navigation route, the information collection unit 21 may collect information on a road on which the vehicle is driving from the navigation device 10. Here, the road information may include information on a highway if the vehicle is supposed to travel onto an exit ramp, but keeps travelling on the highway without travelling onto the exit ramp at a highway junction. This is because the navigation device 10 fails to recognize the deviation of the vehicle from the route, and continues to provide information on the exit ramp. In addition, the road information may include information on the exit ramp if the vehicle is supposed to keep travelling on the highway without travelling onto the exit ramp at the highway junction, but is travelling onto the exit ramp at the highway junction. This is because the navigation device 10 fails to recognize the deviation of the vehicle from the route, and continues to provide information on the highway.

The driving lane determination unit 22 may determine a lane on which the vehicle is currently driving. For example, the driving lane determination unit 22 may include a first lane attribute information extractor, a second lane attribute information extractor, and a driving lane determining device.

The first lane attribute information extractor may extract front lane attribute information from an image in front of the vehicle. The first lane attribute information extractor may include a front-view camera and an image processor.

The front-view camera may be mounted on the front of the vehicle, and photograph an image in front of the vehicle.

The image processor may perform image processing to extract the front lane attribute information from the front-view image. Here, the front lane attribute information may include a lane type (e.g., solid line, dashed line, double solid line, left dashed line & right solid line, left solid line & right dashed line, short dashed line, thick dashed line, and the like), a line color (e.g., white, yellow, blue, red, and the like), and lane change information (e.g., left change, right change).

The image processor may extract lane attribute information on a predetermined number of lines depending on a current driving lane. For example, the image processor may extract lane attribute information on first and second lines to the left/right of the current driving lane.

The second lane attribute information extractor may extract current position lane attribute information from lane attribute database (DB) depending on a current position and a direction of travel of the vehicle. The second lane attribute information extractor may include a sensor, a global positioning system (GPS) antenna, a memory, and a lane attribute information output device.

The sensor may be mounted in the vehicle to measure vehicle information. Here, the vehicle information may include direction, attitude, speed, and the like. The sensor may include a geomagnetic sensor (e.g., orientation sensor), a gyro sensor (e.g., angular velocity sensor), a vehicle speed sensor, and the like.

The GPS antenna may be mounted in the vehicle and receive satellite information (e.g., satellite signal) propagated from a satellite.

The memory may store map data and lane attribute DB. The lane attribute DB may be configured in a tree structure, and include one or more road (link) data. The road data may be composed of one or more spot data, and the spot data may include an offset from a link starting point, the total number of lanes, lane attribute information (type, color, and direction) for each line/lane, and the like.

The lane attribute information output device may use the vehicle information and the satellite information to calculate the current position and direction of travel of the vehicle. In addition, the lane attribute information output device may search for a driving road on the basis of the current position and the direction of travel, and extract lane attribute information of a specific spot on the driving road within a predetermined distance in front of the vehicle from the lane attribute DB to output the current position lane attribute information.

The driving lane determining device may determine the current driving lane of the vehicle on the basis of the front lane attribute information and the current position lane attribute information. The driving lane determining device may include a driving lane matching device, a driving lane tracker, and a fusion device.

The driving lane matching device may compare the front lane attribute information with the current position lane attribute information to calculate a matching point of each lane. That is, the driving lane matching device may set a matching point to be 1 when the front lane attribute information matches the current position lane attribute information, and set a matching point to be 0 when the front lane attribute information does not match the current position lane attribute information to calculate the matching point. In this case, the driving lane matching device may use a predetermined recognition rate of the front-view camera as a weight w to calculate the matching point.

For example, when the vehicle is driving on a second lane of a four-lane highway, the driving lane matching device may calculate a matching point MP for each lane using the current position lane attribute information (MAP), the front lane attribute information (CAM), and the front-view camera recognition rate (weight, w).

The driving lane matching device may calculate the matching points for each lane, and determine a lane having the largest value among the matching points as a driving lane. For example, the driving lane matching device may determine a second lane having the largest matching point among the matching points for each lane as a driving lane. The driving lane matching device may output the determined driving lane as a driving lane matching result.

The driving lane tracker may calculate a driving lane (e.g., current driving lane) at the current time on the basis of a previous driving lane determined at a previous time and the lane change information output from the first lane attribute information extractor. In addition, the driving lane tracker may output the current driving lane as a driving lane tracking result.

For example, when the driving lane tracker receives a left lane change signal from the first lane attribute information extractor, the driving lane tracker may subtract −1 from a previous driving lane number to calculate a current driving lane number. Meanwhile, when the driving lane tracker receives a right lane change signal from the first lane attribute information extractor, the driving lane tracker may add +1 to the previous driving lane number to calculate the current driving lane number. Without the input of the lane change information from the first lane attribute information extractor, the driving lane tracker may maintain the previous driving lane number.

The driving lane tracker may use the current position lane attribute information output from the second lane attribute information extractor to validate the calculated driving lane. When the driving road is a general road, the driving lane tracker may check whether the calculated driving lane is equal to or less than 0 or exceeds the total number of lanes. The driving lane tracker may determine the validation of the driving lane at a point in time at which the vehicle passes through a point where the road merges or splits.

The driving lane tracker may increase a tracking counter by +1 every time it tracks the driving lane. The tracking counter may be used for tracking validation with respect to further tracking results.

The fusion device may finally determine the driving lane on which the vehicle is currently driving depending on the results of the driving lane matching device and the driving lane tracker.

The fusion device may determine the driving lane tracking result or the driving lane matching result as a final driving lane in accordance with circumstances.

The fusion device may divide its mode into 12 modes according to the driving lane matching and tracking results and result states.

In a first mode (“mode 01”), there is one driving lane matching result, and the driving lane tracking result tracked within a set time matches the driving lane matching result. Here, the set time is a time which is not affected by errors of camera data and map data when tracking the driving lane, and it may be a reference time arbitrarily set by a designer.

In a second mode (“mode 02”), there is one driving lane matching result, and the driving lane tracking result tracked within the set time does not match the driving lane matching result.

In a third mode (“mode 03”), the driving lane tracking result is obtained and output when exceeding the set time, and there is one driving lane matching result.

In a fourth mode (“mode 04”), there is no driving lane tracking result, and one driving lane matching result is input.

In a fifth mode (“mode 05”), there are a plurality of driving lane matching results, and the driving lane tracking result output within the set time is included in the plurality of driving lane matching results.

In a sixth mode (“mode 06”), there are a plurality of driving lane matching results, and the driving lane tracking result output within the set time is not included in the plurality of driving lane matching results.

In a seventh mode (“mode 07”), the driving lane tracking result output when exceeding the set time is included in the plurality of driving lane matching results.

In an eighth mode (“mode 08”), the driving lane tracking result output when exceeding the set time is not included in the plurality of driving lane matching results.

In a ninth mode (“mode 09”), there is no driving lane tracking result, and there are only the plurality of driving lane matching results.

In a tenth mode (“mode 10”), there is the driving lane tracking result within the set time, and there is no driving lane matching result.

In an eleventh mode (“mode 11”), there is the driving lane tracking result which exceeds the set time, but there is no driving lane matching result.

In a twelfth mode (“mode 12”), there is no driving lane tracking result and no driving lane matching result.

In any one of the first, third, and fourth modes, the fusion device may determine the driving lane matching result as the final driving lane, and initialize the tracking counter.

In the fifth mode, the fusion device may determine the driving lane tracking result as the final driving lane, and initialize the tracking counter. In any one of the second, sixth, seventh, tenth, and eleventh modes, the fusion device may determine the driving lane tracking result as the final driving lane. In any one of the eighth, ninth, and twelfth modes, the fusion device may determine no recognition of the driving lane.

The fusion device may feedback the finally determined driving lane to the driving lane tracker.

The route deviation determination unit 23 may determine whether or not the vehicle deviates from the navigation route at the highway junction. In other words, the route deviation determination unit 23 may detect whether or not the vehicle is travelling on a lane connected to the exit ramp when passing through the highway junction, to determine whether or not the vehicle deviates from the navigation route.

The road information extraction unit 24 may extract information on the road on which the vehicle is driving from the navigation information collected by the information collection unit 21. In other words, the road information extraction unit 24 may extract the highway information when the vehicle deviates from the navigation route and is travelling on the highway, and extract the exit ramp information when the vehicle deviates from the navigation route and is travelling onto the exit ramp.

The control unit 25 may control partially automated driving of the vehicle on the basis of the road information extracted by the road information extraction unit 24. In other words, when the vehicle deviates from the navigation route and is travelling on the highway, the control unit 25 may activate function A and function B, and deactivate function C. In addition, when the vehicle deviates from the navigation route and is travelling onto the exit ramp, the control unit 25 may deactivate function A and function B, and activate function C.

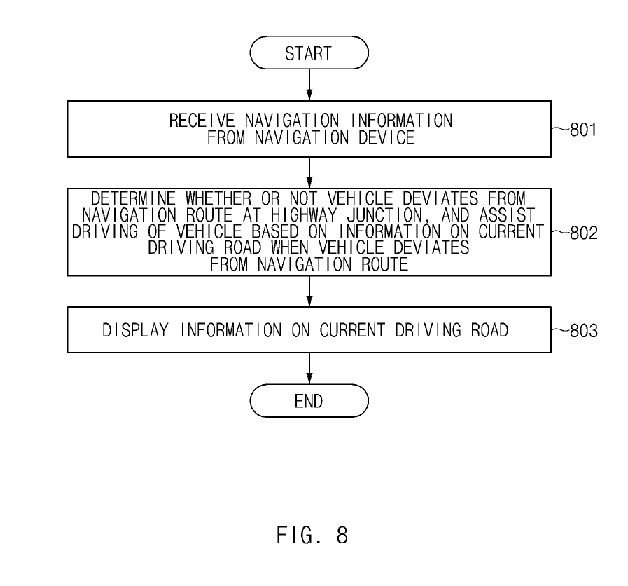

FIG. 8 illustrates a flowchart of an operating method of a driving assist system using navigation information, according to embodiments of the present disclosure.

First of all, navigation information may be provided from the navigation device 10 in step 801.

Next, the controller 20 may determine whether or not a vehicle deviates from a navigation route at a highway junction, and assist the driving of the vehicle on the basis of information on a road on which the vehicle is currently driving when the vehicle deviates from the navigation route in step 802.

Then, the display device 30 may display the information on the road on which the vehicle is currently driving in step 803.

As set forth above, the driving assist system and method, according to embodiments, may be capable of assisting the driving of the vehicle normally without errors even when the vehicle deviates from the navigation route, by determining whether or not the vehicle deviates from the navigation route on the basis of the driving lane of the vehicle at the highway junction.

Hereinabove, although the present disclosure has been described with reference to embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A driving assist system for a vehicle using navigation information, the system comprising:
a navigation device providing navigation information;
a controller determining whether the vehicle deviates from a navigation route based on a driving lane of the vehicle at or near a junction of a highway, and when the controller determines that the vehicle deviates from the navigation route, performing at least one driving assist operation based on information of a road on which the vehicle is currently driving; and
a display device displaying the information of the road on which the vehicle is currently driving.

2. The system according to claim 1, wherein the at least one driving assist operation performed by the controller includes at least one of: an auto-setting function for setting a longitudinal control speed of the vehicle to a speed limit of the driving road, a lane change assist function for assisting a lane change when a driver operates a turn signal, and a speed control function for reducing a speed of the vehicle at an exit ramp of the highway.

3. The system according to claim 2, wherein the controller determines that the vehicle deviates from the navigation route when: (a) the navigation route includes a path allowing the vehicle to pass through an exit ramp at the junction and (b) the vehicle does not keep travelling on a lane of the highway connected to the exit ramp until reaching the junction.

4. The system according to claim 3, wherein the controller performs the at least one driving assist operation based on information of the highway on which the vehicle is currently driving when the controller determines that the vehicle deviates from the navigation route.

5. The system according to claim 4, wherein the controller activates the auto-setting function and the lane change assist function, and deactivates the speed control function.

6. The system according to claim 4, wherein the controller controls the display device to display the information of the road on which the vehicle is currently driving while the vehicle drives on the highway.

7. The system according to claim 2, wherein the controller determines that the vehicle deviates from the navigation route when: (a) the navigation route includes a path allowing the vehicle to keep travelling on the highway without travelling onto an exit ramp at the junction and (b) the vehicle keeps travelling on a lane of the highway connected to the exit ramp until reaching the junction.

8. The system according to claim 7, wherein the controller performs the at least one driving assist operation based on information of the exit ramp on which the vehicle is currently driving when the controller determines that the vehicle deviates from the navigation route.

9. The system according to claim 8, wherein the controller deactivates the auto-setting function and the lane change assist function, and activates the speed control function.

10. The system according to claim 8, wherein the controller controls the display device to display the information of the road on which the vehicle is currently driving while the vehicle drives on the exit ramp.

11. An operating method of a driving assist system for a vehicle using navigation information, the method comprising steps of:
providing, by a navigation device, navigation information;
determining, by a controller, whether the vehicle deviates from a navigation route based on a driving lane of the vehicle at or near a junction of a highway;
performing, by the controller, at least one driving assist operation based on information of a road on which the vehicle is currently driving when the vehicle deviates from the navigation route; and
displaying, by a display device, the information of the road on which the vehicle is currently driving.

12. The method according to claim 11, wherein the at least one driving assist operation includes at least one of: an auto-setting function for setting a longitudinal control speed of the vehicle to a speed limit of the driving road, a lane change assist function for assisting a lane change when a driver operates a turn signal, and a speed control function for reducing a speed of the vehicle at an exit ramp of the highway.

13. The method according to claim 12, wherein the determining of whether the vehicle deviates from a navigation route comprises determining that the vehicle deviates from the navigation route when: (a) the navigation route includes a path allowing the vehicle to pass through an exit ramp at the junction and (b) the vehicle does not keep travelling on a lane of the highway connected to the exit ramp until reaching the junction.

14. The method according to claim 13, wherein the performing of the at least one driving assist operation comprises performing the at least one driving assist operation based on information of the highway on which the vehicle is currently driving when it is determined that the vehicle deviates from the navigation route.

15. The method according to claim 14, wherein the performing of the at least one driving assist operation comprises activating the auto-setting function and the lane change assist function, and deactivating the speed control function.

16. The method according to claim 14, further comprising controlling, by the controller, the display device to display the information of the road on which the vehicle is currently driving while the vehicle drives on the highway.

17. The method according to claim 12, wherein the determining of whether the vehicle deviates from a navigation route comprises determining that the vehicle deviates from the navigation route when: (a) the navigation route includes a path allowing the vehicle to keep travelling on the highway without travelling onto an exit ramp at the junction and (b) the vehicle keeps travelling on a lane of the highway connected to the exit ramp until reaching the junction.

18. The method according to claim 17, wherein the performing of the at least one driving assist operation comprises performing the at least one driving assist operation based on information of the exit ramp on which the vehicle is currently driving when it is determined that the vehicle deviates from the navigation route.

19. The method according to claim 18, wherein the performing of the at least one driving assist operation comprises deactivating the auto-setting function and the lane change assist function, and activating the speed control function.

20. The method according to claim 18, further comprising controlling the display device to display the information of the road on which the vehicle is currently driving while the vehicle drives on the exit ramp.
